(19) United States
(12) Patent Application Publication
(10) Pub. No.: US 2025/0356599 A1
(43) Pub. Date: Nov. 20, 2025

(54) TECHNIQUES FOR PROVIDING ASSISTANCE IN MOUNTING OBJECTS UPON SURFACES

(71) Applicant: Harbinger, LLC, Livermore, CA (US)

(72) Inventor: Todd William ALLUM, Livermore, CA (US)

(21) Appl. No.: 19/202,807

(22) Filed: May 8, 2025

Related U.S. Application Data
(60) Provisional application No. 63/647,316, filed on May 14, 2024.

(51) Int. Cl. G06T 19/00; G06T 19/20

(52) U.S. Cl. CPC G06T 19/006; G06T 19/20; G06T 2219/2004; G06T 2219/2016

(57) ABSTRACT

One embodiment sets forth a technique for providing assistance in mounting one or more objects on a surface. According to some embodiments, the technique includes the steps of generating a virtual rendering of at least a portion of the surface, configuring the virtual rendering to enable a user to select a first location on the surface for mounting a first object, receiving mounting hardware information associated with the first object, determining, based on the first location and the mounting hardware information, an anchor spot on the surface for attaching a surface-mountable anchor, and displaying, via a user interface, a visible indicium that provides operational assistance for placing a mark on the anchor spot for attaching the surface-mountable anchor to the surface.

### CROSS-REFERENCE TO RELATED APPLICATIONS

The present application claims the benefit of U.S. Provisional Application titled, “GENERATING AND DISPLAYING ALIGNMENT INDICATORS IN AN AUGMENTED REALITY ENVIRONMENT,” filed on May 14, 2024, and having Ser. No. 63/647,316. The subject matter of this related application is hereby incorporated herein by reference.

### BACKGROUND

### Field of the Various Embodiments

Embodiments of the present disclosure relate to an assistance system and, more specifically, to techniques for providing assistance in mounting objects upon surfaces.

### Description of the Related Art

People with limited handyman skills may face challenges when performing certain types of tasks. For example, a person who lacks a first kind of handyman skill may find it challenging to repair a broken mechanical gadget. A person who lacks a second kind of handyman skill may find it challenging to repair a faulty electrical fixture. A person who lacks a third kind of handyman skill may find it challenging to repair a leaky plumbing fixture. In some cases, such people may seek help in performing such tasks. Understandably, there are several drawbacks associated with various types of help that may be provided for accomplishing the various types of tasks.

At least one drawback associated with an example scenario involving providing of assistance to a person with limited handyman skills for accomplishing a task—such as hanging a picture on a wall—may require the person to use a laser distance measuring device, a spirit level, and a plumb line. The person may be unfamiliar with the use of such tools and may therefore decide to employ a trial-and-error approach that does not require use of the tools. The trial-and-error approach involves the person eye-balling the wall, making a rough guess as to where to mount the picture frame, hammering a nail into place on a first anchor spot on the wall, hanging the picture frame on the nail, stepping back to view the handiwork, and likely feeling dissatisfied with various aspects of the end result. For example, a poor spacing may be present between the picture frame and an object already mounted on the wall, a size of the picture frame may be unsuitable for the mounted location, and/or there may be a poor visual appeal of the overall wall after mounting the picture frame. Oftentimes, the person decides to unmount the picture frame, remove the nail, and then repeat the mounting procedure one or more times, thereby creating one or more unnecessary holes in the wall and expending additional time.

As the foregoing illustrates, what is needed in the art is a more effective technique for assisting those who desire to hang a picture on a wall.

### SUMMARY

One embodiment sets forth a computer-implemented method for providing assistance in mounting one or more objects on a surface. According to some embodiments, the technique includes the steps of generating a virtual rendering of at least a portion of the surface, configuring the virtual rendering to enable a user to select a first location on the surface for mounting a first object, receiving mounting hardware information associated with the first object, determining, based on the first location and the mounting hardware information, an anchor spot on the surface for attaching a surface-mountable anchor, and displaying, via a user interface, a visible indicium that provides operational assistance for placing a mark on the anchor spot for attaching the surface-mountable anchor to the surface.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques over the prior art is that the disclosed techniques provide a solution to eliminate damage that can be caused to a surface when following a trial-and-error approach for mounting an object upon the surface (such as, for example, for mounting a picture frame upon a wall). In one embodiment, a handheld mobile device (a smartphone, for example) can be used by an individual to evaluate a virtual rendering of a wall that is generated by an augmented reality engine. The virtual rendering includes a virtual representation of an object, such as a picture frame, along with virtual representations of other objects that may already be mounted upon the wall. The individual may drag and drop the virtual representation of the picture frame to a desired spot on the virtual rendering. The augmented reality engine then generates a visible indicium based on automatically evaluating information pertaining to mounting hardware included on the picture frame. The individual can use the visible indicum to walk towards the wall and place a mark upon the wall at a spot that corresponds to the visible indicium on the handheld mobile device. A surface-mountable anchor can be attached to the wall at the mark, and then the picture frame can be mounted upon the surface-mountable anchor.

The technical advantages of the embodiments described herein provide technological advancements over prior art approaches that involve the use of various tools to perform the task of mounting an object upon a surface.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates an example scenario for describing an assistance system that assists a person mounting an object upon a surface in accordance with various embodiments.

FIG. 2 illustrates a first example operational step of a method sequence to assist the person mounting the object upon the surface according to an embodiment.

FIG. 3 illustrates a second example operational step of the method sequence to assist the person mounting the object upon the surface according to an embodiment.

FIG. 4 illustrates a third example operational step of the method sequence to assist the person mounting the object upon the surface according to an embodiment.

FIG. 5 illustrates a fourth example operational step of the method sequence to assist the person mounting the object upon the surface according to an embodiment.

FIG. 6 illustrates a fifth example operational step of the sequence to assist the person mounting the object upon the surface according to an embodiment.

FIG. 7 illustrates a sixth example operational step of the method sequence to assist the person mounting the object upon the surface according to an embodiment.

FIG. 8 illustrates a seventh example operational step of the method sequence to assist the person mounting the object upon the surface according to an embodiment.

FIG. 9 illustrates a flowchart of a method to assist a person mounting an object upon a surface in accordance with various embodiments.

FIG. 10 is a detailed illustration of a computing device that can implement the example scenario illustrated in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

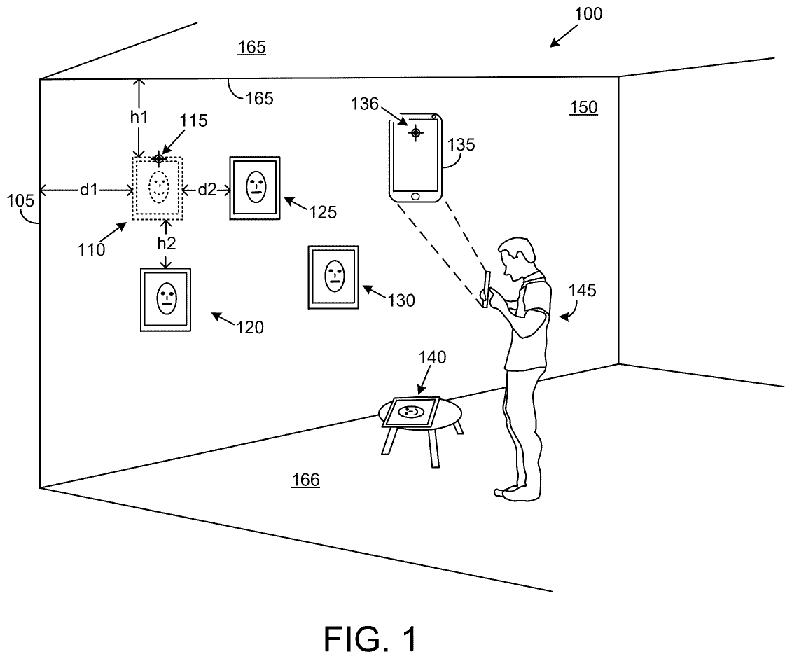

FIG. 1 illustrates an example scenario for describing an assistance system 100 in accordance with various embodiments. The assistance system 100 comprises a handheld device 135 that includes hardware and software configured to assist a person to mount an object upon a surface. In the illustrated example scenario, the object is a picture frame 140 that an individual 145 desires to mount on a wall 150. In other implementations, the object can be any of various other items such as, for example, a decorative item (painting, wall lamp, wall vase, etc.), a piece of art (sculpture, statue, etc.), a utility item (bookshelf, clock, electrical outlet, etc.), a light fixture, a ceiling fan, and the surface can be any of various other types of surfaces such as, for example, a ceiling, a floor, an external surface of a building or object. The assistance system 100 can further include other components such as a cloud computer or a server that is communicatively coupled to the handheld device 135 to enable the handheld device 135 automatically obtain various types of information pertaining to the embodiment.

The individual 145 who is holding the handheld device 135 (a smartphone, for example) desires to mount the picture frame 140 upon the wall 150 at a location 110 of his/her choice. A first step of an example mounting procedure in accordance with an embodiment involves providing the handheld device 135 with information about the picture frame 140. This action can be carried out by the individual 145 operating a camera of the handheld device 135 to capture an image of a backside of the picture frame 140. Typically, the backside of the picture frame 140 includes mounting hardware for mounting the picture frame 140. A processor of the handheld device 135 evaluates the captured image to obtain information about the picture frame 140 such as dimensions of the picture frame 140 and details of the mounting hardware. In an example implementation, the captured image is a scaled replica of the picture frame 140 that is generated by an Augmented Reality (AR) engine provided in the handheld device 135. The scaled replica can be evaluated by the processor to determine various parameters of the picture frame 140 (length, width, shape, etc.) and to determine location information of the mounting hardware with reference to one or more parts of the picture frame 140. In one case, the location information of the mounting hardware can be provided in the form of X-Y location coordinates with reference to one or more edges of the picture frame 140.

The processor of the handheld device 135 can also obtain additional information about the mounting hardware, such as, for example, a type of the mounting hardware (a hook, a recess, a metal loop, a mounting ring, a hanger, a mounting plate having a recess, a length of wire, etc.) and a compatibility of the mounting hardware with a surface-mountable anchor (a nail, a nail-mounting plate, a hole in the surface, a hook, a hanger etc.) that is attachable to the wall 150.

In another embodiment, mounting hardware information can be obtained via input provided by the individual 145. The individual 145 may obtain the information from various sources such as from an information brochure provided by a manufacturer of the picture frame 140. In an example scenario, the individual 145 can input the information via a touch screen of the handheld device 135.

In yet another embodiment, the mounting hardware information can be automatically obtained by the handheld device 135 from information provided on a website (manufacturer website, supplier website, store website, etc.) or from information provided on a cloud computer or a server that is communicatively coupled to the handheld device 135 via a communications network. The communications network can be, for example, a cellular network or the Internet. This embodiment can enable the user to visualize a frame that is advertised for sale, on a wall of his/her house or workplace, etc., before making a decision about purchasing the frame.

In yet another embodiment, the mounting hardware information can be automatically obtained by the handheld device 135 from a source such as a cloud computer or a server that is communicatively coupled to the handheld device 135 via a communications network. The communications network can be, for example, a cellular network or the Internet.

After obtaining the information about the picture frame 140 and the mounting hardware, the handheld device 135 generates a virtual representation of the picture frame 140 and stores the virtual representation in a memory provided in the handheld device 135 or elsewhere (cloud storage, server, etc.). In an example implementation, the virtual representation of the picture frame 140 is generated by an augmented reality (AR) engine provided in the handheld device 135.

The next step of the mounting procedure involves the AR engine generating a virtual rendering of at least a portion of the wall 150 based on one or more images captured by the individual 145 by use of the camera and/or based on using a light detecting and ranging (LIDAR) sensor of the handheld device 135 to generate a 3D rendering of the wall. The 3D rendering provides high accuracy measurements of various parameters such as, for example, various separation distances between objects and dimensional information of various objects. The virtual rendering of the wall 150 can be displayed on a display screen of the handheld device 135 and can include various objects such as other picture frames, mechanical fixtures, electrical fixtures, etc. that may be present on the wall 150. The virtual rendering of the wall 150 replicates to scale, various dimensional parameters of the wall 150, such as a height of the wall 150, a width of the wall 150, separation distances between edges of the wall 150 and one or more objects mounted on the wall 150, and separation distances between the various objects.

The virtual representation of the picture frame 140 that was stored in memory may then be displayed on the display screen of the handheld device 135 at any of various locations outside a boundary of the virtual rendering of the wall 150. The individual 145 drags the virtual representation of the picture frame 140 into the virtual rendering of the wall 150 and drops the virtual representation of the picture frame 140 at the location 110 which suits his/her personal taste. Selection of the location 110 by the individual 145 and/or by the processor of the handheld device 135 as described below, can be influenced by various factors such as a size of the picture frame 140, a shape of the picture frame 140, presence of one or more objects on the wall 150 (picture frame 120, picture frame 125, and/or picture frame 130, for example), distances from one or more wall edges (from wall edge 105, for example), a distance from the floor 166, and/or a distance from the ceiling 165.

After detecting placement of the virtual representation of the picture frame 140 upon the desired location 110, the processor of the handheld device 135 determines various parameters such as, for example, a first separation distance “d1” between a first edge of the picture frame 140 and the wall edge 105, a second separation distance “d2” between a second edge of the picture frame 140 and an edge of the picture frame 125, a third separation distance “h1” between a top edge of the picture frame 140 and the ceiling 165 of the room, and a fourth separation distance “h2” between a bottom edge of the picture frame 140 and a top edge of the picture frame 120.

Based on the various types of information described above with reference to the picture frame 140, the mounting hardware on the picture frame 140, and the location 110, the AR engine generates a visible indicium 136. The visible indicium 136 assists the individual 145 in a cooperative manner to place a mark on an anchor spot 115 that corresponds to the location 110 on the display screen of the handheld device 135. A surface-mountable anchor can then be attached to the anchor spot 115 for mounting the picture frame 140 upon the wall 150.

An example procedure for using the visible indicium 136 to place the mark at the anchor spot 115 can include the processor of the handheld device 135 displaying a set of instructions to be followed by the individual 145. In accordance with the instructions, the individual 145 holds up the handheld device 135 with the camera facing the wall 150 and moves towards the wall 150 while watching the visible indicium 136 and holding up a marking element, such as a pencil, for marking the anchor spot 115. The processor of the handheld device 135 evaluates images provided by the camera and/or input obtained from sensors provided in the handheld device 135 to detect the handheld device 135 having been moved to a spot that is located inside a predefined threshold distance with respect to the wall 150. In an example implementation, the handheld device 135 then generates an image of a hand of the individual 145 holding the pencil, and generates a signal (an audible signal and/or a visible signal such as flashing visible indicium 136) to prompt the individual 145 to place a pencil mark upon the anchor spot 115. The individual 145 can then attach a surface-mountable anchor (a nail, a nail-mounting plate, a hole in the surface, a hook, a hanger etc.) upon the pencil mark for mounting the picture frame 140.

The general overview provided above with reference to the picture frame 140 can be replicated for mounting additional objects upon the wall 150. In some cases, mounting an additional object upon the wall 150 can entail re-doing at least some of the actions described above in order to move the picture frame 140 from the location 110 to a different location on the wall 150 to make room for the additional object or to provide various desired separation distances.

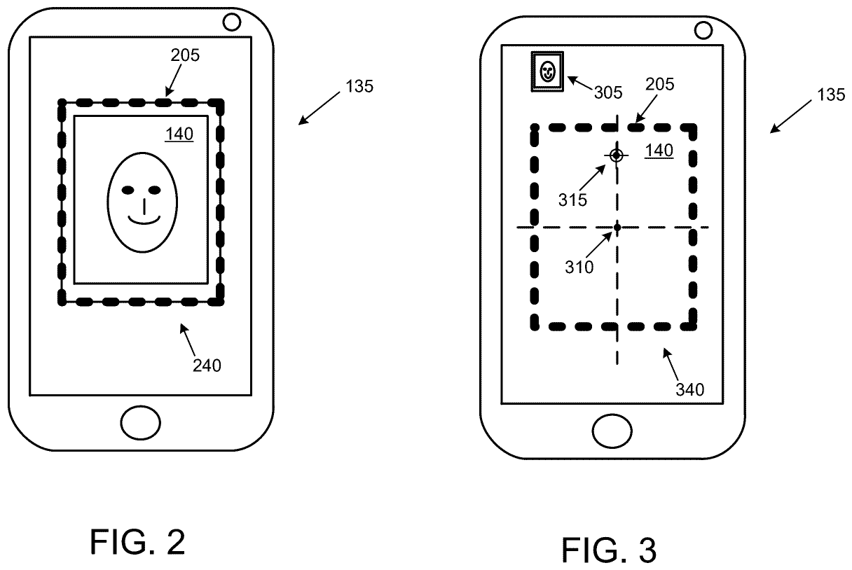

FIG. 2 illustrates a first example operational step of a method sequence to assist the individual 145 mount the picture frame 140 upon the wall 150 according to an embodiment. In some embodiments, some aspects of the method sequence are implemented by an AR engine provided in the handheld device 135.

In one implementation of this first example operational step, the individual 145 operates a camera of the handheld device 135 to capture an image 240 of a front side of the picture frame 140. The processor of the handheld device 135 evaluates the image 240 to obtain information about the picture frame 140, such as, for example, a boundary profile 205 of the picture frame 140. The boundary profile 205 can be based on evaluating length and width parameters of the outside edges of the image 240 of the picture frame 140. In another implementation of this example operational step, a LIDAR sensor of the handheld device 135 can be used to obtain precise measurements of the boundary profile 205.

FIG. 3 illustrates a second example operational step of the method sequence to assist the individual 145 mount the picture frame 140 upon the wall 150 according to the embodiment. In one implementation of this second example operational step, the individual 145 operates a camera of the handheld device 135 to capture an image 340 of a back side of the picture frame 140 where mounting hardware for mounting the picture frame 140 is located. In another implementation of this example operational step, a LIDAR sensor of the handheld device 135 can be used to obtain precise measurements pertaining to the mounting hardware on the back side of the picture frame 140.

The processor of the handheld device 135 evaluates the image 340 to obtain information about the mounting hardware. The evaluation can include using the boundary profile 205 to identify a placement location 315 of the mounting hardware on the picture frame 140. In an example implementation, the location 315 of the mounting hardware on the picture frame 140 is determined based on determining a center 310 of the boundary profile 205. In another example implementation, the location of the mounting hardware on the picture frame 140 is determined based on determining a first separation distance between the mounting hardware and a top horizontal edge of the boundary profile 205. In another example implementation, the location of the mounting hardware of the picture frame 140 is determined based on a first separation distance between the mounting hardware and the top horizontal edge of the boundary profile 205 and one or more additional separation distances such as a second separation distance between the mounting hardware and one or both vertical edges of the boundary profile 205, and/or a third separation distance between the mounting hardware and the center 310 of the boundary profile 205.

The AR engine of the handheld device 135 may further generate a virtual representation 305 of the picture frame 140 and place the virtual representation 305 at a location outside the boundary profile 205. In the example illustration, the virtual representation 305 has been placed in an area above the boundary profile 205.

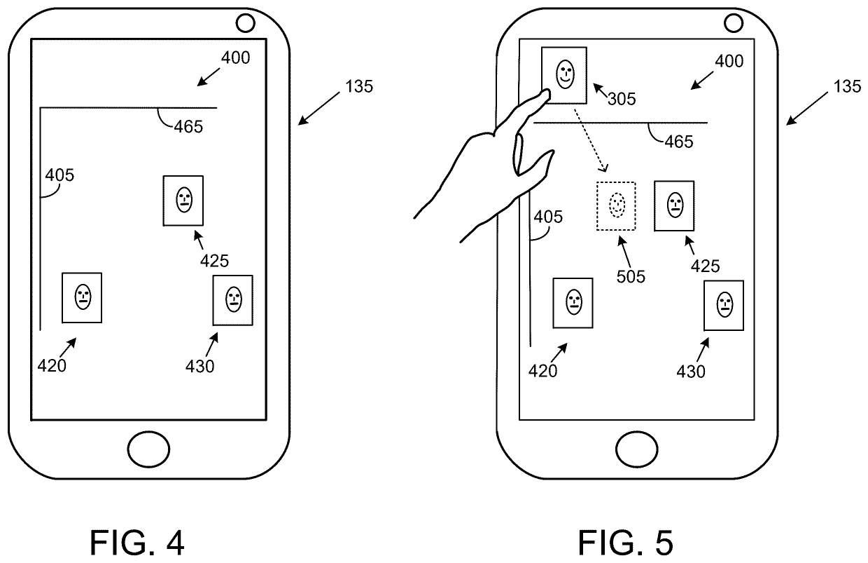

FIG. 4 illustrates a third example operational step of the method sequence to assist the individual 145 mount the picture frame 140 upon the wall 150 according to the embodiment. In this step, the AR engine generates a virtual rendering 400 of a portion of the wall 150 based on one or more images captured by the individual 145 via operation of the camera and/or coupled with the LiDAR sensor of the handheld device 135. The virtual rendering 400 replicates to scale, various dimensional parameters of the wall 150, such as a height of the wall 150, a width of the wall 150, and further replicates separation distances associated with various objects mounted on the wall 150.

The virtual rendering 400 can include virtual representations of various objects that are already present on the wall 150. In the illustrated example, the virtual rendering 400 includes a virtual representation 420 of the picture frame 120, a virtual representation 425 of the picture frame 125, and a virtual representation 430 of the picture frame 130 that are shown mounted on the wall 150 in FIG. 1.

FIG. 5 illustrates a fourth example operational step of the method sequence to assist the individual 145 mount the picture frame 140 upon the wall 150 according to the embodiment. In this step, the individual 145 drags and drops the virtual representation 305 of the picture frame 140 on to the virtual rendering 400 and moves the virtual representation 305 around to specify the location 110 based on his/her personal taste. The location 110 on the wall 150 is indicated in the virtual rendering 400 by the virtual location 505.

In an example implementation, the virtual rendering 400 is configured to provide one or more auto-snap locations for placement of the virtual representation 305 in the virtual rendering 400. An example auto-snap location can be determined by the AR engine based on a size of the picture frame 140 and a separation distance between the picture frame 140 and an occluding object. Examples of occluding objects are a door frame, a window frame, an adjacent wall, the ceiling 165, the floor 166, another picture frame mounted on the wall 150, an object mounted on the wall 150, and an object such as a piece of furniture that is placed on the floor 166 abutting the wall 150.

In another example implementation, the virtual rendering 400 is configured to display one or more preferred locations for placement of the virtual representation 305. The preferred locations can be determined by the AR engine based on various factors and parameters, such as, for example, based on conclusions drawn by the AR engine by evaluating an arrangement of various objects upon the wall 150. For example, evaluating an arrangement of the picture frame 125, the picture frame 120, and the picture frame 130 with respect to each other can provide an indication to the AR engine that the individual 145 prefers pictures arranged in an asymmetrical pattern. Evaluating the arrangement can also provide an indication to the AR engine of various dimensional preferences of the individual 145 such as a preferred height of one or more picture frames with respect to the floor 166 and/or preferred drop-down distances between the ceiling 165 and one or more picture frames.

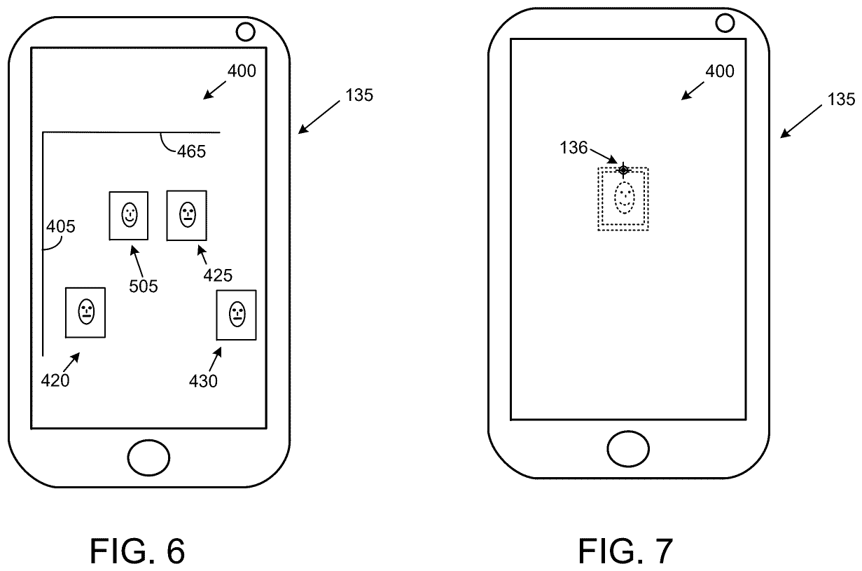

FIG. 6 illustrates a fifth example operational step of the method sequence to assist the individual 145 mount the picture frame 140 upon the wall 150 according to the embodiment. In this step, the handheld device 135 displays the virtual rendering 400 of the wall 150 with the virtual representation 305 placed at the location that has been selected by the individual 145 in the step described above with reference to FIG. 5. Also shown are the virtual representations of other objects such as the other picture frames shown in FIG. 1. The individual 145 can examine the arrangement of the virtual representations of the various objects with respect to each other and make a determination whether he/she likes the arrangement. The individual 145 can also share the virtual representation of the various objects on the wall to others via text, email, social media, etc., for input or to allow the others to utilize the virtual representations on a remote computing device to provide, collaborate on, etc., alternative arrangement ideas, recommendations, etc. If the individual 145 is dissatisfied with the arrangement, then some or all of the steps described above (such as with reference to FIG. 5) can be recursively repeated until a satisfactory arrangement is achieved.

FIG. 7 illustrates a sixth example operational step of the method sequence to assist the individual 145 mount the picture frame 140 upon the wall 150 according to the embodiment. In this step, the processor of handheld device 135 determines a position of the visible indicium 136 on the display screen of the handheld device 135 based on the identified location 315 of the mounting hardware on the picture frame 140 as described above with reference to FIG. 3. The processor displays the visible indicium 136 (in this example, in the form of a cross-hair symbol) upon a dashed-line (or grayed) version of the virtual representation 305. The visible indicium 136 is configured to provide operational assistance to the individual 145 for placing a mark on the location 110 shown in FIG. 1.

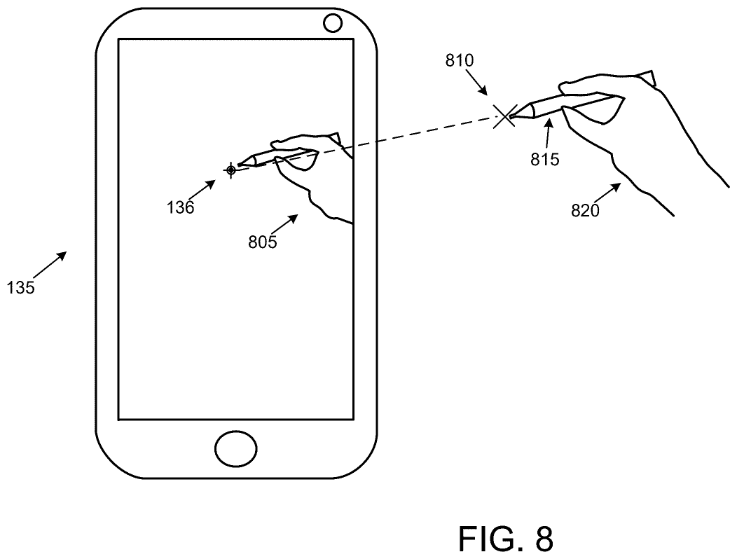

FIG. 8 illustrates a seventh example operational step of the method sequence to assist the individual 145 mount the picture frame 140 upon the wall 150, according to the embodiment. This step involves the use of the visible indicium 136 to assist the individual 145 place an anchor or a mark at the anchor spot 115. In an example implementation, the processor of the handheld device 135 displays a set of instructions to be followed by the individual 145. In accordance with the instructions, the individual 145 holds up the handheld device 135 with the camera facing the wall 150 and moves towards the wall 150 while watching the visible indicium 136 and holding up a pencil 815 for marking the anchor spot 115. Alternatively, the individual 145 holds up the handheld device 135 with the camera facing the wall 150 and moves towards the wall 150 while watching the visible indicium 136 with a pencil 815 attached to the handheld device 135 for marking the anchor spot 115. In yet another configuration, the individual 145 holds up the handheld device 135 with the camera facing the wall 150 and moves towards the wall 150 while watching the visible indicium 136 with an anchor installation tool attached to the handheld device 135 for installing the anchor at the anchor spot 115. In the illustrated implementation, the AR engine displays an image of a hand 820 of the individual 145 holding a marking element (pencil 815).

As the individual 145 moves towards the wall 150, the processor of the handheld device 135 evaluates images provided by the camera and/or input obtained from sensors (object sensor, infrared detector, accelerometer, gyroscope, etc.) provided in the handheld device 135 to detect the handheld device 135 having been moved to a spot that is located inside a predefined threshold distance with respect to the wall 150. The processor then generates a signal (an audible signal and/or a visible signal as described below) to prompt the individual 145 to place a pencil mark 810 upon the anchor spot 115. The individual 145 can subsequently attach a surface-mountable anchor (a nail, a nail-mounting plate, a hole in the surface, a hook, a hanger etc.) upon the pencil mark 810 for mounting the picture frame 140.

In an example implementation, a visual signal that is generated for prompting the individual to place the pencil mark 810 upon the anchor spot 115 is based on the visible indicium 136 having a first color indicative of the visible indicium 136 being misaligned with respect to the anchor spot 115 and a second color that is indicative of the visible indicium 136 being aligned with respect to the anchor spot 115.

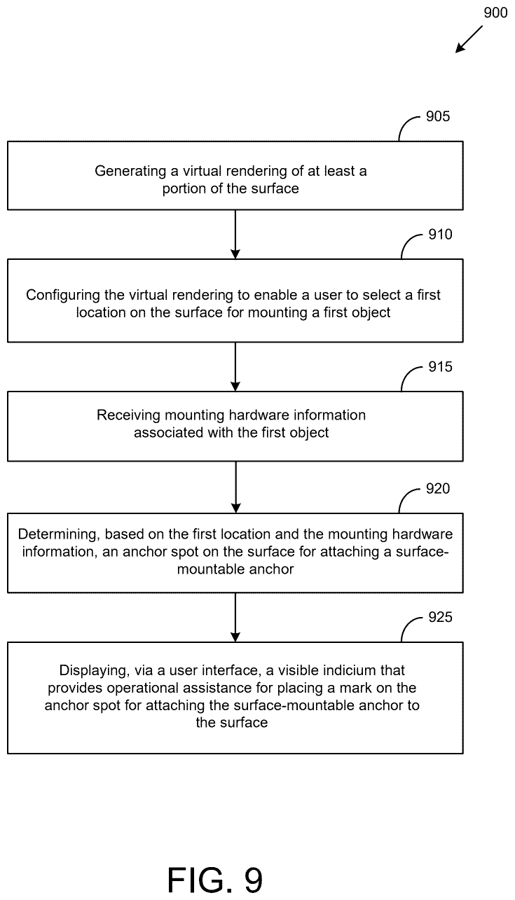

FIG. 9 illustrates a flowchart 900 of a method to assist a person mounting an object upon a surface in accordance with various embodiments. The method can be implemented by a processor based on an AR engine. At block 905, a virtual rendering of at least a portion of a surface is generated. An example implementation of this step is described above with reference to FIG. 4 which shows a virtual rendering of the wall 150 shown in FIG. 1.

At block 910, the virtual rendering is configured to enable a user to select a first location on the surface for mounting a first object. This aspect is described above with reference to FIG. 5 which illustrates the individual 145 dragging and dropping the virtual representation 305 of the picture frame 140 on to the virtual rendering of the wall 150. The first location on the surface is the location 110 on the wall 150, which is indicated in the virtual rendering 400 by the virtual location 505.

At block 915, mounting hardware information associated with the first object is received. In one example embodiment, the processor obtains the mounting hardware information based on evaluating one or images of the picture frame 140. In another example embodiment, the processor obtains the mounting hardware information based on input provided by the individual 145. In another example embodiment, the processor obtains the mounting hardware information from imagery provided online by a manufacturer or supplier, or a source such as a cloud computer or a server that is communicatively coupled to the handheld device 135.

At block 920, an anchor spot on the surface is determined for attaching a surface-mountable anchor. The determination is based on the first location and the mounting hardware information. This aspect is described above with respect to FIG. 6 and FIG. 7.

At block 925, a visible indicium is displayed upon a user interface of the handheld device (a display screen, for example). The visible indicium provides the individual 145 with operational assistance for placing a mark on the anchor spot for attaching the surface-mountable anchor to the surface. The visible indicium can then be used as a guide for mounting the first object upon the surface via the surface-mountable anchor. This aspect is described above with respect to FIG. 7 and FIG. 8.

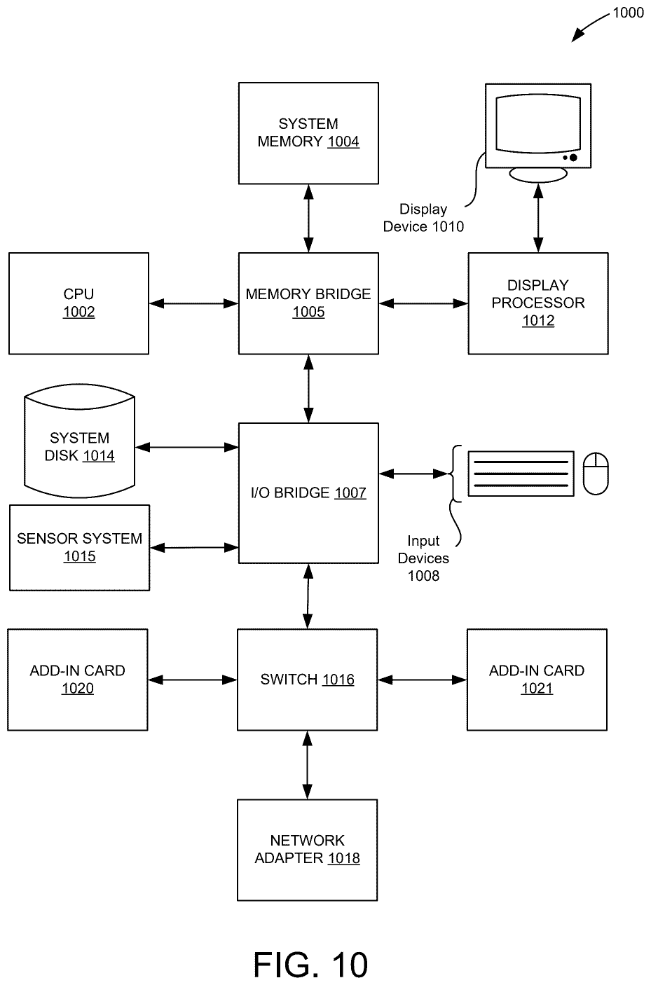

FIG. 10 is a more detailed illustration of a computing device that can implement the functionalities of the entities illustrated in FIG. 1, according to various embodiments. This figure in no way limits or is intended to limit the scope of the various embodiments. In various implementations, system 1000 may be an augmented reality, virtual reality, or mixed reality system or device, a personal computer, video game console, personal digital assistant, mobile phone, mobile device, or any other device suitable for practicing the various embodiments. Further, in various embodiments, any combination of two or more systems 1000 may be coupled together to practice one or more aspects of the various embodiments.

As shown, system 1000 includes a central processing unit (CPU) 1002 and a system memory 1004 communicating via a bus path that may include a memory bridge 1005. CPU 1002 includes one or more processing cores, and, in operation, CPU 1002 is the master processor of system 1000, controlling and coordinating operations of other system components. System memory 1004 stores software applications and data for use by CPU 1002. CPU 1002 runs software applications and optionally an operating system. Memory bridge 1005, which may be, e.g., a Northbridge chip, is connected via a bus or other communication path (e.g., a HyperTransport link) to an I/O (input/output) bridge 1007. I/O bridge 1007, which may be, e.g., a Southbridge chip, receives user input from one or more user input devices 1008 (e.g., keyboard, mouse, joystick, digitizer tablets, touch pads, touch screens, still or video cameras, motion sensors, and/or microphones) and forwards the input to CPU 1002 via memory bridge 1005. Input devices coupled to the I/O bridge 1007 can further include a sensor system 1015. Sensor system 1015 can include one or more devices such as, for example, an object sensor, an infrared sensor, an accelerometer sensor, a gyroscope sensor, and a LIDAR sensor.

A display processor 1012 is coupled to memory bridge 1005 via a bus or other communication path (e.g., a PCI Express, Accelerated Graphics Port, or HyperTransport link); in one embodiment display processor 1012 is a graphics subsystem that includes at least one graphics processing unit (GPU) and graphics memory. Graphics memory includes a display memory (e.g., a frame buffer) used for storing pixel data for each pixel of an output image. Graphics memory can be integrated in the same device as the GPU, connected as a separate device with the GPU, and/or implemented within system memory 1004.

Display processor 1012 periodically delivers pixels to a display device 1010 (e.g., a screen or conventional CRT, plasma, OLED, LED, or LCD based monitor or television). Additionally, display processor 1012 may output pixels to film recorders adapted to reproduce computer generated images on photographic film. Display processor 1012 can provide display device 1010 with an analog or digital signal. In various embodiments, the virtual rendering and virtual representations described herein are displayed to one or more users via a user interface such as the display device 1010, and the one or more users can input data into and receive visual output from the various user interfaces.

A system disk 1014 is also connected to I/O bridge 1007 and may be configured to store content and applications and data for use by CPU 1002 and display processor 1012. System disk 1014 provides non-volatile storage for applications and data and may include fixed or removable hard disk drives, flash memory devices, and CD-ROM, DVD-ROM, Blu-ray, HD-DVD, or other magnetic, optical, or solid-state storage devices.

A switch 1016 provides connections between I/O bridge 1007 and other components such as a network adapter 1018 and various add-in cards 1020 and 1021. Network adapter 1018 allows system 1000 to communicate with other systems via an electronic communications network, and may include wired or wireless communication over local area networks and wide area networks such as the Internet.

Other components (not shown), including USB or other port connections, film recording devices, and the like, may also be connected to I/O bridge 1007. For example, an audio processor may be used to generate analog or digital audio output from instructions and/or data provided by CPU 1002, system memory 1004, or system disk 1014. Communication paths interconnecting the various components in FIG. 10 may be implemented using any suitable protocols, such as PCI (Peripheral Component Interconnect), PCI Express (PCI-E), AGP (Accelerated Graphics Port), HyperTransport, or any other bus or point-to-point communication protocol(s), and connections between different devices may use different protocols, as is known in the art.

In one embodiment, display processor 1012 incorporates circuitry optimized for graphics and video processing, including, for example, video output circuitry, and constitutes a graphics processing unit (GPU). In another embodiment, display processor 1012 incorporates circuitry optimized for general purpose processing. In yet another embodiment, display processor 1012 may be integrated with one or more other system elements, such as the memory bridge 1005, CPU 1002, and I/O bridge 1007 to form a system on chip (SoC). In still further embodiments, display processor 1012 is omitted and software executed by CPU 1002 performs the functions of display processor 1012.

Pixel data can be provided to display processor 1012 directly from CPU 1002. In some embodiments, instructions and/or data representing an object or scene are provided to a render farm or a set of server computers, each similar to system 1000, via network adapter 1018 or system disk 1014. The render farm generates one or more rendered images of the object or scene using the provided instructions and/or data. These rendered images may be stored on computer-readable media in a digital format and optionally returned to system 1000 for display. Similarly, stereo image pairs processed by display processor 1012 may be output to other systems for display, stored in system disk 1014, or stored on computer-readable media in a digital format.

Alternatively, CPU 1002 provides display processor 1012 with data and/or instructions defining the desired output images, from which display processor 1012 generates the pixel data of one or more output images, including characterizing and/or adjusting the offset between stereo image pairs. The data and/or instructions defining the desired output images can be stored in system memory 1004 or graphics memory within display processor 1012. In an embodiment, display processor 1012 includes 3D rendering capabilities for generating pixel data for output images from instructions and data defining the geometry, lighting, shading, texturing, motion, and/or camera parameters for a scene. Display processor 1012 can further include one or more programmable execution units capable of executing shader programs, tone mapping programs, and the like.

Further, in other embodiments, CPU 1002 or display processor 1012 may be replaced with or supplemented by any technically feasible form of processing device configured process data and execute program code. Such a processing device could be, for example, a central processing unit (CPU), a graphics processing unit (GPU), an application-specific integrated circuit (ASIC), a field-programmable gate array (FPGA), and so forth. In various embodiments any of the operations and/or functions described herein can be performed by CPU 1002, display processor 1012, or one or more other processing devices or any combination of these different processors.

CPU 1002, render farm, and/or display processor 1012 can employ any surface or volume rendering technique known in the art to create one or more rendered images from the provided data and instructions, including rasterization, scanline rendering REYES or micropolygon rendering, ray casting, ray tracing, image-based rendering techniques, and/or combinations of these and any other rendering or image processing techniques known in the art.

In other contemplated embodiments, system 1000 may be a robot or robotic device and may include CPU 1002 and/or other processing units or devices and system memory 1004. In such embodiments, system 1000 may or may not include other elements shown in FIG. 10. System memory 1004 and/or other memory units or devices in system 1000 may include instructions that, when executed, cause the robot or robotic device represented by system 1000 to perform one or more operations, steps, tasks, or the like.

It will be appreciated that the system shown herein is illustrative and that variations and modifications are possible. The connection topology, including the number and arrangement of bridges, may be modified as desired. For instance, in some embodiments, system memory 1004 is connected to CPU 1002 directly rather than through a bridge, and other devices communicate with system memory 1004 via memory bridge 1005 and CPU 1002. In other alternative topologies display processor 1012 is connected to I/O bridge 1007 or directly to CPU 1002, rather than to memory bridge 1005. In still other embodiments, I/O bridge 1007 and memory bridge 1005 might be integrated into a single chip. The particular components shown herein are optional; for instance, any number of add-in cards or peripheral devices might be supported. In some embodiments, switch 1016 is eliminated, and network adapter 1018 and add-in cards 1020, 1021 connect directly to I/O bridge 1007.

In sum, the disclosed techniques set forth a simple-to-use system that can be used by an individual for mounting an object upon a surface. In one embodiment, a handheld device (a smartphone, for example) can be used by an individual to evaluate a virtual rendering of a wall that is generated by an augmented reality engine. The virtual rendering includes a virtual representation of an object, such as a picture frame, along with virtual representations of other objects that may already be mounted upon the wall. The individual may drag and drop the virtual representation of the picture frame to a personally desirable spot on the virtual rendering. The augmented reality engine then generates a visible indicium based on automatically evaluating information pertaining to mounting hardware provided on the picture frame. The individual can use the visible indicum to walk towards the wall and place a mark upon the wall at a spot that corresponds to the visible indicium on the handheld device. A surface-mountable anchor can be attached to the wall at the mark and the picture frame can be mounted upon the surface-mountable anchor.

One technical advantage of the disclosed techniques over the prior art is that the disclosed techniques provide a solution to eliminate damage that can be caused to a surface when following a trial-and-error approach for mounting an object upon the surface (such as, for example, for mounting a picture frame upon a wall). In one embodiment, a handheld mobile device (a smartphone, for example) can be used by an individual to evaluate a virtual rendering of a wall that is generated by an augmented reality engine. The virtual rendering includes a virtual representation of an object, such as a picture frame, along with virtual representations of other objects that may already be mounted upon the wall. The individual may drag and drop the virtual representation of the picture frame to a desired spot on the virtual rendering. The augmented reality engine then generates a visible indicium based on automatically evaluating information pertaining to mounting hardware included on the picture frame. The individual can use the visible indicum to walk towards the wall and place a mark upon the wall at a spot that corresponds to the visible indicium on the handheld mobile device. A surface-mountable anchor can be attached to the wall at the mark, and then the picture frame can be mounted upon the surface-mountable anchor.
1. In some embodiments, a computer-implemented method for providing assistance in mounting one or more objects on a surface comprises: generating a virtual rendering of at least a portion of the surface; configuring the virtual rendering to enable a user to select a first location on the surface for mounting a first object; determining, based on the first location, an anchor spot on the surface for attaching the first object; and displaying, via a user interface, a visible indicium that provides operational assistance for attaching the first object onto the surface.
2. The computer-implemented method of clause 1, further comprising receiving mounting hardware information associated with the first object, wherein: the anchor spot is further determined based on the mounting hardware information; the visible indicium provides operational assistance for placing a mark on the anchor spot for attaching a surface mountable anchor; and the first object is attached to the surface via the surface mountable anchor.
3. The computer-implemented method of clause 2, wherein the virtual rendering of the at least a portion of the surface is a scaled version of the at least a portion of the surface that is generated via an augmented reality engine, and wherein configuring the virtual rendering to enable selecting of the first location on the surface comprises: displaying on a display screen of a mobile device, the virtual rendering of the at least a portion of the surface; generating a virtual representation of the first object to scale; and enabling dragging and dropping of the virtual representation of the first object upon the virtual rendering of the at least a portion of the surface.
4. The computer-implemented method of clause 3, wherein receiving mounting hardware information associated with the first object comprises: capturing an image of the first object; and evaluating the image to determine one or more dimensions of the first object.
5. The computer-implemented method of clause 2, wherein the virtual rendering of the at least a portion of the surface is a scaled version of the at least a portion of the surface that is generated via an augmented reality engine, and wherein configuring the virtual rendering to enable selecting of the first location on the surface comprises: configuring the virtual rendering to provide at least a first auto-snap position for placement of a virtual representation of the first object, the first auto-snap position determined based on a size of the first object and a first separation distance between the first object and an occluding object.
6. The computer-implemented method of clause 5, wherein selecting the first location on the surface is performed by dragging and dropping the virtual representation of the first object upon the first auto-snap position provided in the virtual rendering, and wherein the occluding object is one of a door frame, a window frame, another surface, a second object mounted upon the portion of the surface, or a third object abutting the portion of the surface.
7. The computer-implemented method of clause 2, wherein the operational assistance provided by the visible indicium is based on the visible indicium having a first color indicative of the visible indicium being misaligned with respect to the anchor spot and a second color that is indicative of the visible indicium being aligned with respect to the anchor spot.
8. The computer-implemented method of clause 2, wherein the visible indicium includes a cross-hair graphic, and wherein placing of the mark on the anchor spot is based on use of the cross-hair graphic and a marking element.
9. The computer-implemented method of clause 2, wherein the visible indicium is displayed on a display screen of a mobile device, and the method further comprises: detecting the mobile device having been moved to a spot that is located inside a predefined threshold distance with respect to the surface; and generating, upon detecting the mobile device being located inside the predefined threshold distance, at least one of an audible signal or a visible signal to prompt marking of the anchor spot on the surface.
10. The computer-implemented method of clause 2, wherein receiving mounting hardware information associated with the first object is based on at least one of determining a type of a mounting hardware component, a size of the mounting hardware component, or a location of the mounting hardware component upon the first object.
11. The computer-implemented method of clause 2, wherein receiving mounting hardware information associated with the first object comprises: capturing an image of the first object; and evaluating the image to determine a location of a mounting hardware component with reference to one or more edges of the first object.
12. In some embodiments, one or more non-transitory computer readable media store instructions that, when executed by one or more processors, cause the one or more processors to provide assistance in mounting one or more objects on a surface, by performing the operations of: generating a virtual rendering of at least a portion of the surface; configuring the virtual rendering to enable a user to select a first location on the surface for mounting a first object; determining, based on the first location, an anchor spot on the surface for attaching the first object; and displaying, via a user interface, a visible indicium that provides operational assistance for attaching the first object onto the surface.
13. The one or more non-transitory computer readable media of clause 12, wherein the operations further include receiving mounting hardware information associated with the first object, and wherein: the anchor spot is further determined based on the mounting hardware information; the visible indicium provides operational assistance for placing a mark on the anchor spot for attaching a surface mountable anchor; and the first object is attached to the surface via the surface mountable anchor.
14. The one or more non-transitory computer readable media of clause 13, wherein the virtual rendering of the at least a portion of the surface is a scaled version of the at least a portion of the surface that is generated via an augmented reality engine, and wherein configuring the virtual rendering to enable selecting of the first location on the surface comprises: displaying on a display screen of a mobile device, the virtual rendering of the at least a portion of the surface; generating a virtual representation of the first object to scale; and enabling dragging and dropping of the virtual representation of the first object upon the virtual rendering of the at least a portion of the surface.
15. The one or more non-transitory computer readable media of clause 14, wherein receiving mounting hardware information associated with the first object comprises: capturing an image of the first object; and evaluating the image to determine one or more dimensions of the first object.
16. The one or more non-transitory computer readable media of clause 13, wherein the virtual rendering of the at least a portion of the surface is a scaled version of the at least a portion of the surface that is generated via an augmented reality engine, and wherein configuring the virtual rendering to enable selecting of the first location on the surface comprises: configuring the virtual rendering to provide at least a first auto-snap position for placement of a virtual representation of the first object, the first auto-snap position determined based on a size of the first object and a first separation distance between the first object and an occluding object.
17. The one or more non-transitory computer readable media of clause 16, wherein selecting the first location on the surface is performed by dragging and dropping the virtual representation of the first object upon the first auto-snap position provided in the virtual rendering, and wherein the occluding object is one of a door frame, a window frame, another surface, a second object mounted upon the portion of the surface, or a third object abutting the portion of the surface.
18. The one or more non-transitory computer readable media of clause 16, wherein the operational assistance provided by the visible indicium is based on the visible indicium having a first color indicative of the visible indicium being misaligned with respect to the anchor spot and a second color that is indicative of the visible indicium being aligned with respect to the anchor spot.
19. The one or more non-transitory computer readable media of clause 13, wherein the virtual rendering of the at least a portion of the surface is a scaled version of the at least a portion of the surface that is generated via an augmented reality engine, and wherein the instructions further comprise: generating a virtual representation of the first object to scale; displaying on a display screen of a mobile device, the virtual rendering of the at least a portion of the surface; detecting a placement of the virtual representation of the first object inside the virtual rendering of the at least a portion of the surface; evaluating one or more separation distances between the virtual representation of the first object and one or more occluding objects present in the virtual rendering of the at least a portion of the surface; and determining the anchor spot on the surface based on the one or more separation distances.
20. The one or more non-transitory computer readable media of clause 19, wherein the one or more separation distances include at least one a first separation distance between an outer edge of the virtual representation of the first object and at least one of the one or more occluding objects or a second separation distance between a reference point selected on the virtual representation of the first object and at least one of the one or more occluding objects.
21. The one or more non-transitory computer readable media of clause 13, wherein the first object includes a mounting hardware component that is one a hook, a metal loop, a mounting ring, a mounting plate having a recess, or a length of wire, and wherein the surface mountable anchor is a compatible one of a nail, a nail-mounting plate, or a hole in the surface.
22. In some embodiments, a computer system comprises one or more memories that include instructions, and one or more processors that are coupled to the one or more memories and that, when executing the instructions, are configured to provide assistance in mounting one or more objects on a surface, by performing the operations of: generating a virtual rendering of at least a portion of the surface; configuring the virtual rendering to enable a user to select a first location on the surface for mounting a first object; determining, based on the first location, an anchor spot on the surface for attaching the first object; and displaying, via a user interface, a visible indicium that provides operational assistance for attaching the first object onto the surface.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention has been described above with reference to specific embodiments. Persons of ordinary skill in the art, however, will understand that various modifications and changes may be made thereto without departing from the broader spirit and scope of the invention as set forth in the appended claims. For example, and without limitation, although many of the descriptions herein refer to specific types of I/O devices that may acquire data associated with an object of interest, persons skilled in the art will appreciate that the systems and techniques described herein are applicable to other types of I/O devices. The foregoing description and drawings are, accordingly, to be regarded in an illustrative rather than a restrictive sense.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for providing assistance in mounting one or more objects on a surface, the computer-implemented method comprising:
generating a virtual rendering of at least a portion of the surface;
configuring the virtual rendering to enable a user to select a first location on the surface for mounting a first object;
determining, based on the first location, an anchor spot on the surface for attaching the first object; and
displaying, via a user interface, a visible indicium that provides operational assistance for attaching the first object onto the surface.

2. The computer-implemented method of claim 1, further comprising receiving mounting hardware information associated with the first object, wherein:
the anchor spot is further determined based on the mounting hardware information;
the visible indicium provides operational assistance for placing a mark on the anchor spot for attaching a surface mountable anchor; and
the first object is attached to the surface via the surface mountable anchor.

3. The computer-implemented method of claim 2, wherein the virtual rendering of the at least a portion of the surface is a scaled version of the at least a portion of the surface that is generated via an augmented reality engine, and wherein configuring the virtual rendering to enable selecting of the first location on the surface comprises:
displaying on a display screen of a mobile device, the virtual rendering of the at least a portion of the surface;
generating a virtual representation of the first object to scale; and
enabling dragging and dropping of the virtual representation of the first object upon the virtual rendering of the at least a portion of the surface.

4. The computer-implemented method of claim 3, wherein receiving mounting hardware information associated with the first object comprises:
capturing an image of the first object; and
evaluating the image to determine one or more dimensions of the first object.

5. The computer-implemented method of claim 2, wherein the virtual rendering of the at least a portion of the surface is a scaled version of the at least a portion of the surface that is generated via an augmented reality engine, and wherein configuring the virtual rendering to enable selecting of the first location on the surface comprises:
configuring the virtual rendering to provide at least a first auto-snap position for placement of a virtual representation of the first object, the first auto-snap position determined based on a size of the first object and a first separation distance between the first object and an occluding object.

6. The computer-implemented method of claim 5, wherein selecting the first location on the surface is performed by dragging and dropping the virtual representation of the first object upon the first auto-snap position provided in the virtual rendering, and wherein the occluding object is one of a door frame, a window frame, another surface, a second object mounted upon the portion of the surface, or a third object abutting the portion of the surface.

7. The computer-implemented method of claim 2, wherein the operational assistance provided by the visible indicium is based on the visible indicium having a first color indicative of the visible indicium being misaligned with respect to the anchor spot and a second color that is indicative of the visible indicium being aligned with respect to the anchor spot.

8. The computer-implemented method of claim 2, wherein the visible indicium includes a cross-hair graphic, and wherein placing of the mark on the anchor spot is based on use of the cross-hair graphic and a marking element.

9. The computer-implemented method of claim 2, wherein the visible indicium is displayed on a display screen of a mobile device, and the method further comprises:
detecting the mobile device having been moved to a spot that is located inside a predefined threshold distance with respect to the surface; and
generating, upon detecting the mobile device being located inside the predefined threshold distance, at least one of an audible signal or a visible signal to prompt marking of the anchor spot on the surface.

10. The computer-implemented method of claim 2, wherein receiving mounting hardware information associated with the first object is based on at least one of determining a type of a mounting hardware component, a size of the mounting hardware component, or a location of the mounting hardware component upon the first object.

11. The computer-implemented method of claim 2, wherein receiving mounting hardware information associated with the first object comprises:
capturing an image of the first object; and
evaluating the image to determine a location of a mounting hardware component with reference to one or more edges of the first object.

12. One or more non-transitory computer readable media storing instructions that, when executed by one or more processors, cause the one or more processors to provide assistance in mounting one or more objects on a surface, by performing the operations of:
generating a virtual rendering of at least a portion of the surface;
configuring the virtual rendering to enable a user to select a first location on the surface for mounting a first object;
determining, based on the first location, an anchor spot on the surface for attaching the first object; and
displaying, via a user interface, a visible indicium that provides operational assistance for attaching the first object onto the surface.

13. The one or more non-transitory computer readable media of claim 12, wherein the operations further include receiving mounting hardware information associated with the first object, and wherein:
the anchor spot is further determined based on the mounting hardware information;
the visible indicium provides operational assistance for placing a mark on the anchor spot for attaching a surface mountable anchor; and
the first object is attached to the surface via the surface mountable anchor.

14. The one or more non-transitory computer readable media of claim 13, wherein the virtual rendering of the at least a portion of the surface is a scaled version of the at least a portion of the surface that is generated via an augmented reality engine, and wherein configuring the virtual rendering to enable selecting of the first location on the surface comprises:
displaying on a display screen of a mobile device, the virtual rendering of the at least a portion of the surface;
generating a virtual representation of the first object to scale; and
enabling dragging and dropping of the virtual representation of the first object upon the virtual rendering of the at least a portion of the surface.

15. The one or more non-transitory computer readable media of claim 14, wherein receiving mounting hardware information associated with the first object comprises:
capturing an image of the first object; and
evaluating the image to determine one or more dimensions of the first object.

16. The one or more non-transitory computer readable media of claim 13, wherein the virtual rendering of the at least a portion of the surface is a scaled version of the at least a portion of the surface that is generated via an augmented reality engine, and wherein configuring the virtual rendering to enable selecting of the first location on the surface comprises:
configuring the virtual rendering to provide at least a first auto-snap position for placement of a virtual representation of the first object, the first auto-snap position determined based on a size of the first object and a first separation distance between the first object and an occluding object.

17. The one or more non-transitory computer readable media of claim 16, wherein selecting the first location on the surface is performed by dragging and dropping the virtual representation of the first object upon the first auto-snap position provided in the virtual rendering, and wherein the occluding object is one of a door frame, a window frame, another surface, a second object mounted upon the portion of the surface, or a third object abutting the portion of the surface.

18. The one or more non-transitory computer readable media of claim 16, wherein the operational assistance provided by the visible indicium is based on the visible indicium having a first color indicative of the visible indicium being misaligned with respect to the anchor spot and a second color that is indicative of the visible indicium being aligned with respect to the anchor spot.

19. The one or more non-transitory computer readable media of claim 13, wherein the virtual rendering of the at least a portion of the surface is a scaled version of the at least a portion of the surface that is generated via an augmented reality engine, and wherein the instructions further comprise:
generating a virtual representation of the first object to scale;
displaying on a display screen of a mobile device, the virtual rendering of the at least a portion of the surface;
detecting a placement of the virtual representation of the first object inside the virtual rendering of the at least a portion of the surface;
evaluating one or more separation distances between the virtual representation of the first object and one or more occluding objects present in the virtual rendering of the at least a portion of the surface; and
determining the anchor spot on the surface based on the one or more separation distances.

20. The one or more non-transitory computer readable media of claim 19, wherein the one or more separation distances include at least one a first separation distance between an outer edge of the virtual representation of the first object and at least one of the one or more occluding objects or a second separation distance between a reference point selected on the virtual representation of the first object and at least one of the one or more occluding objects.

21. The one or more non-transitory computer readable media of claim 13, wherein the first object includes a mounting hardware component that is one a hook, a metal loop, a mounting ring, a mounting plate having a recess, or a length of wire, and wherein the surface mountable anchor is a compatible one of a nail, a nail-mounting plate, or a hole in the surface.

22. A computer system, comprising:
one or more memories that include instructions; and
one or more processors that are coupled to the one or more memories and, when executing the instructions, are configured to provide assistance in mounting one or more objects on a surface, by performing the operations of:
generating a virtual rendering of at least a portion of the surface;
configuring the virtual rendering to enable a user to select a first location on the surface for mounting a first object;
determining, based on the first location, an anchor spot on the surface for attaching the first object; and
displaying, via a user interface, a visible indicium that provides operational assistance for attaching the first object onto the surface.
